(19) United States
(12) Patent Application Publication
(10) Pub. No.: US 2026/0350565 A1
(43) Pub. Date: Nov. 5, 2026

(54) METHOD FOR STREAMLINING INSURANCE PAYMENTS TO A DENTAL PRACTICE AND DISPLAYING ELECTRONIC EOBs TO END USERS

(71) Applicant: Woods Technologies, Inc., Elk Grove, CA (US)

(72) Inventor: Samuel Rockwood, Carlsbad, CA (US)

(73) Assignee: Woods Technologies, Inc., Elk Grove, CA (US)

(21) Appl. No.: 19/665,246

(22) Filed: May 1, 2026

Related U.S. Application Data
(60) Provisional application No. 63/798,060, filed on May 1, 2025.

(51) Int. Cl. G06Q 20/10; G06Q 20/02; G06Q 40/08

(52) U.S. Cl. CPC G06Q 20/10; G06Q 20/023; G06Q 40/08

(57) ABSTRACT

A process for streamlining payments from an insurance company to a dental practice includes an onboarding session with a dynamic form completed by the dental practice to obtain practice and banking information to generate PDFs that are submitted as ERA/EFT applications to payors to a clearing house used by the dental practice. Making a request for the clearing house to activate an electronic data interchange (EDI) process placing the insurance company, the clearing house, and the dental practice in communication for payment processing. Once the EDI/EFT process is activated, receive raw text files that include the remittance information of the payment sent by the insurance company. Periodically download new raw data files, convert them into digital EOBs and process the data using a backend API, data scrubbing agent, and database. Display selected data fields from the processed data on a dashboard for end users of a dental practice.

The present application claims priority from United States Provisional Patent Application No. 63/798,060 filed on May 1, 2025; the subject matter of which is incorporated by reference in its entirety.

### FIELD OF THE INVENTION

The present invention generally relates to systems and methods for streamlining the processing of insurance claims for a dental practice.

### BACKGROUND

The present invention generally relates to the back-office operations within a dental office or practice (hereinafter “dental practice”), which may include, but are not limited to, the operations of an insurance department, a finance department, a patient interface department that receives and keeps a repository of patient information, any other department or personnel that assists in the operation of the dental practice. More specifically, the present invention is directed toward streamlining the processing of insurance payments.

As a historic benchmark, it is estimated that nearly seventy to eighty percent (70-80%) of payments that dental practices receive from insurance companies are sent by regular mail through the U.S. Postal Service. Accordingly, these payments arrive in the form of hardcopy checks that must be recorded, manually signed, deposited at the banking institution chosen by the dental practice, and then given time to be processed by (e.g., clear) said banking institution. Since the vast majority of dental practices may be categorized as small businesses with a need to frequently optimize cashflow and minimize costs for tasks that larger companies may take for granted, the small business dental practices struggle with the traditional hardcopy check process due to the time and resources required. Additionally, it is estimated that insurance companies spend millions each year printing and mailing checks and Explanation of Benefits (EOBs) for dental practices.

However, insurance companies are not content with paying millions on checks and EOBs, so many, but not all, have switched to paying claims through virtual credit cards (VCCs). A VCC arrives at the dental practice in the mail, like a check, but is paid through a credit card terminal, which in turn charges the dental practice an additional three to five percent (3-5%) fee. While the VCC process may appease the insurance companies because it offsets their printing and mailing costs, the VCC method has not gained traction because the dental practices prefer to avoid the high processing fees associated with the VCC process.

### BRIEF SUMMARY OF THE INVENTION

The present invention generally relates to a process for streamlining the receipt of payments from an insurance company to a dental practice. The process includes the steps of (1) obtaining access to the practice management software (PMS) of a dental practice; (2) acquiring specific information about the dental practice; (3) generating one or more portable document files (PDFs) based on the specific information acquired regarding the dental practice; (4) using the PDFs, preparing and submitting one or more electronic remittance advice (ERA) applications to a clearing house used by the dental practice; (5) wherein submitting the ERA application includes making a request for the clearing house to activate an electronic data interchange (EDI) process that places the insurance company, the clearing house, and the dental practice in electronic communication for the purpose of at least processing payment requests originated by the dental practice for payment by the insurance company; (6) after activation of the EDI process, receiving raw text files into the clearing house, wherein the raw data files provide the remittance information of the payment sent by the insurance company; (7) electronically communicating with the clearing house, payor portal (e.g., website), or both on a periodic basis to obtain and download new raw data files; (8) converting the data from the raw data files into digital versions of explanation of benefits (EOBs) forms; (9) acquiring an estimated insurance payment from the PMS of the dental practice; (10) acquiring an actual insurance payment obtained from the conversion of the raw data file; and (11) on an electronic dashboard, displaying the digital EOBs and displaying a comparison of the estimated insurance payment with the actual insurance payment.

In another embodiment, the present invention generally relates to a system for streamlining payments from an insurance company to a dental practice and displaying the status of insurance claims or claimants to end users on a dashboard. The system includes a backend application programming interface (API) controlled by the claims manager for acquiring insurance claim data from a practice management software (PMS) system used by the dental practice. Also using a parsing agent controlled by the claims manager to collect raw data from electronic remittance advice (ERA) applications transmitted from at least one clearing house portal, a payor portal, or both, wherein the parsing agent separates and translates the raw data into legible explanation of benefit (EOB) data. The backend API then combines insurance claim data with the EOB data and transmits the combined data to a data scrubbing agent. The data scrubbing agent evaluates the insurance claim data, the ERA data, or both, by using the context of other insurance claims to determine whether a particular data set received from the backend API includes any errors and then provides the scrubbed data to a database. The database retrieves bank transaction data for insurance claimants of the dental practice, wherein the bank transaction data is received from one or more banking institutions for processing within the database. The database also processes the bank transaction data and the scrubbed data to display select data fields on a dashboard for an end user.

These and other features of the present application will become more apparent upon review of the following detailed description of the example embodiments when taken in conjunction with the drawings and the appended claims.

### BRIEF DESCRIPTION OF THE DRAWINGS

The drawings illustrate only example embodiments and therefore do not limit the scope of the present invention, as other equally effective embodiments are within the scope and spirit of this disclosure. The elements and features shown in the drawings are not necessarily drawn to scale, emphasis instead being placed upon clearly and legibly illustrating the principles of the present invention. Additionally, or alternatively, certain dimensions or features may be exaggerated or shown in a see-through format to help visually convey certain principles, functions or relative locations. In the drawings, similar reference numerals between figures designate like or corresponding, but not necessarily the same, elements. A more complete appreciation of the present invention will become more readily apparent as the invention becomes better understood by reference to the following detailed description when considered in conjunction with the accompanying drawings. The drawings include the following figures.

FIGS. 1A to 1C show a method for streamlining the processing of insurance claims for a dental practice in a secure and cost-effective manner according to an embodiment of the present invention.

FIG. 2 shows a system for streamlining the processing of insurance claims for a dental practice in a secure and cost-effective manner according to an embodiment of the present invention.

FIGS. 3A and 3B shows another method for streamlining the processing of insurance claims for a dental practice using the system of FIG. 2 in a secure and cost-effective manner according to an embodiment of the present invention.

FIGS. 4A and 4B show a dashboard with selected data fields that may be viewable by an end user of a dental practice according to an embodiment of the present invention.

### DETAILED DESCRIPTION

For purposes of promoting an understanding of the principles of the invention, reference will now be made to the exemplary embodiments illustrated in the drawings and specific language will be used to describe the same. It will be apparent, however, to one having ordinary skill in the art that one or more of the steps, elements, components, or other aspects of the present invention as provided in the examples or exemplary embodiments may not be needed to practice the present invention or may be arranged in an order that differs than described below. In other instances, well-known materials or methods have not been described in detail to avoid obscuring the present invention. As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure, or characteristic described in connection with the given example may be included in at least one embodiment of the present invention. Features, structures or characteristics may be combined in any suitable combinations and/or sub-combinations in one or more embodiments or examples.

In the following description, certain specific details are set forth to provide a thorough understanding of various embodiments of the invention. Unless the context requires otherwise, throughout the specification and claims which follow, the word “comprise” and variations thereof, such as, “comprises” and “comprising” are to be construed in an open, inclusive sense, which correlates to “including, but not limited to.” The headings provided herein are for convenience only and do not interpret the scope or meaning of the claimed invention.

For purposes of brevity and clarity, the following terms and variations thereof such as, but not limited to, “insurance company,” “insurer”, “payor,” “clearing house,” and other similar terms as used herein should be broadly interpreted and may be used interchangeably and their usage herein should be considered to be synonymous. For purposes of the present invention, an “insurance company” or “insurer” (e.g., METLIFE®, AETNA®, and DELTA DENTAL®) offers dental coverage to insured members in which the insurer takes on the risk of claims in exchange for a monthly premium paid by the member, employer, or some other person or entity. A “payor” may be any third party that provides funds to a dental practice for services rendered to a patient as adjusted by what amounts are authorized or not authorized by the insurance company. The payor is typically an insurance company, but could also be an employer, a government entity, a membership fund, a professional employer organization (PEO), for example. It is typically understood that the terms “payor” and “insurance company” are often used synonymously or interchangeably even though an insurance company is technically a subset of the payors.

A “clearing house” (e.g., such as VYNE® and DENTALXCHANGE®) is generally understood as an entity that facilitates the electronic data interchange (EDI) between the payors and the dental practices and may also facilitate the transmission of EOBs, electronic remittance advice (ERAs) applications, or both, back to the dental practice from the payor. Most, if not all, dental practices provide for some form of electronic communication between the dental practice’s PMS and the clearing house to send in claims. By way of example, the PMS sends the claim or claims electronically to the clearing house, which then forwards the claim or claims to the correct payor. Moreover, a clearing house may also be the entity that provides facilitation of the EOBs, ERAs, or both sent back to the dental practice from the payor.

In accordance with the purpose(s) of the present disclosure, as embodied and broadly described herein, embodiments of the present disclosure generally relate to a process for streamlining payments from an insurance company to a dental practice. In one embodiment, the process is performed by a claims manager or coordinator (hereinafter “claims manager”) that retrieves, manages, and controls the flow of information across various entities and platforms to achieve the streamlined process. The process typically commences through an onboarding session with a dynamic form completed by the dental practice to obtain specific practice and banking information that are used to generate portable document files (PDFs), which are then submitted as ERA applications to a clearing house used by the dental practice. Submitting the ERA application includes making a request for the clearing house to activate the EDI process that places the insurance company, the clearing house, and the dental practice in electronic communication for the purpose of payment processing. Once the EDI process has been activated, raw text files that include the remittance information of the payment sent by the insurance company are received by the dental practice. Then, the claims manager periodically download new raw data files, converts them into digital EOBs, and then displays the EOBs along with a comparison of the estimated versus actual insurance payment on a dashboard viewable by an end user.

One of the primary issues that confronts dental practices when working with insurance companies is that insurance companies have not made it very straightforward for dental practices to enroll and obtain ERAs from them. Just a single dental practice may work with twenty (20) or more insurance companies, and the insurance companies do not work together. Thus, for a dental practice to receive ERAs in accordance with the current state of the art, the dental practice must work individually with each insurance company or payor. This typically requires the dental practice to electronically access the website portal for each insurance company or payor, which may become unwieldly with respect to time, resources, and data security. Accordingly, one of the many beneficial aspects of the present invention is to bring all ERAs into a single location while eliminating the time and resources the dental practice would otherwise have to dedicate to such tasks.

Another persistent issue that exists between dental practices and insurance companies is that insurance companies have been unable to convince dental practices to utilize EFT processes because the insurance companies are unable to or cannot adequately provide EOBs electronically to the dental practices. This creates a bit of an impasse between dental practices and insurance companies because the insurance companies do not seem to appreciate the need for dental practices to have accurate and adequate EOBs in electronic format and also do not appreciate the time-consuming and cost-prohibitive steps and know-how required by the dental practices to have their PMSs connected and synchronized with multiple insurance companies. Thus, most dental practices have accepted the tried-and-true method of receiving remittance checks and EOBs through the regular mail system, such as the U.S. Postal Service even though most agree that the EFT process is the fastest, safest, and most efficient way of receiving remittance payments.

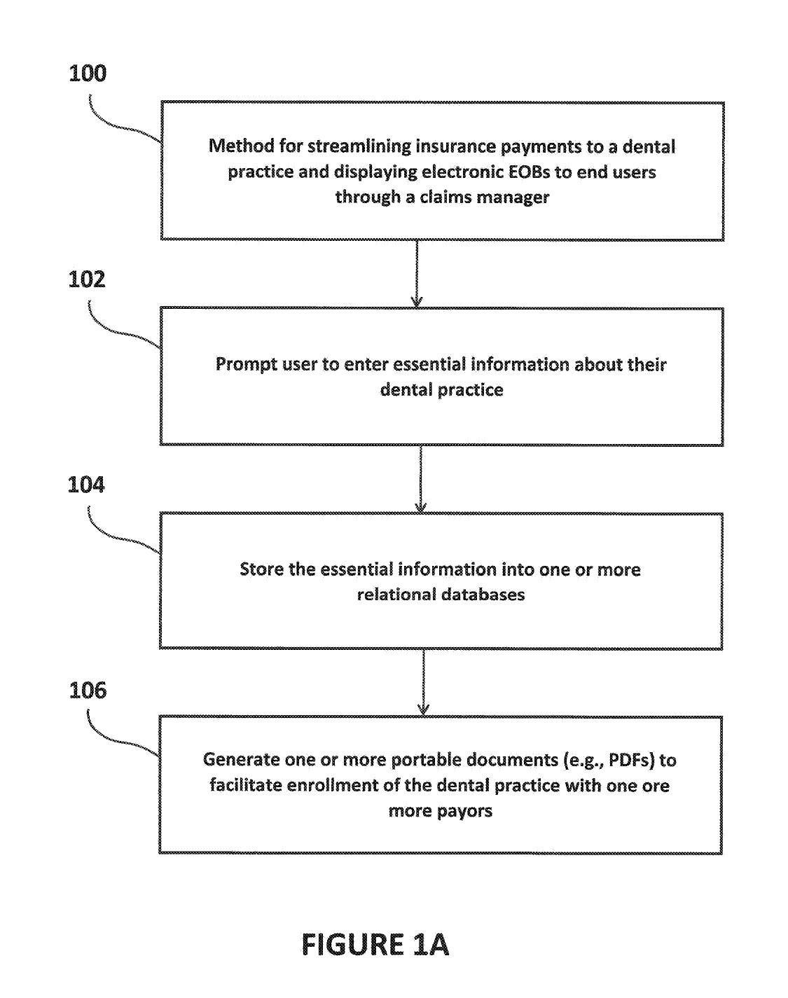

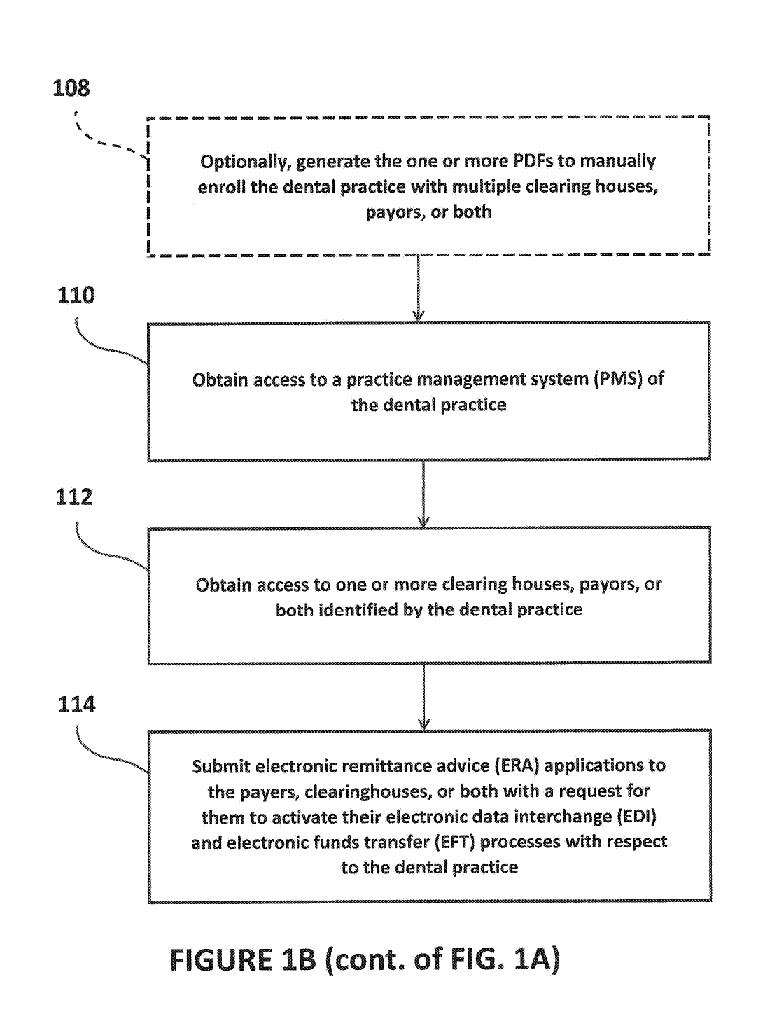

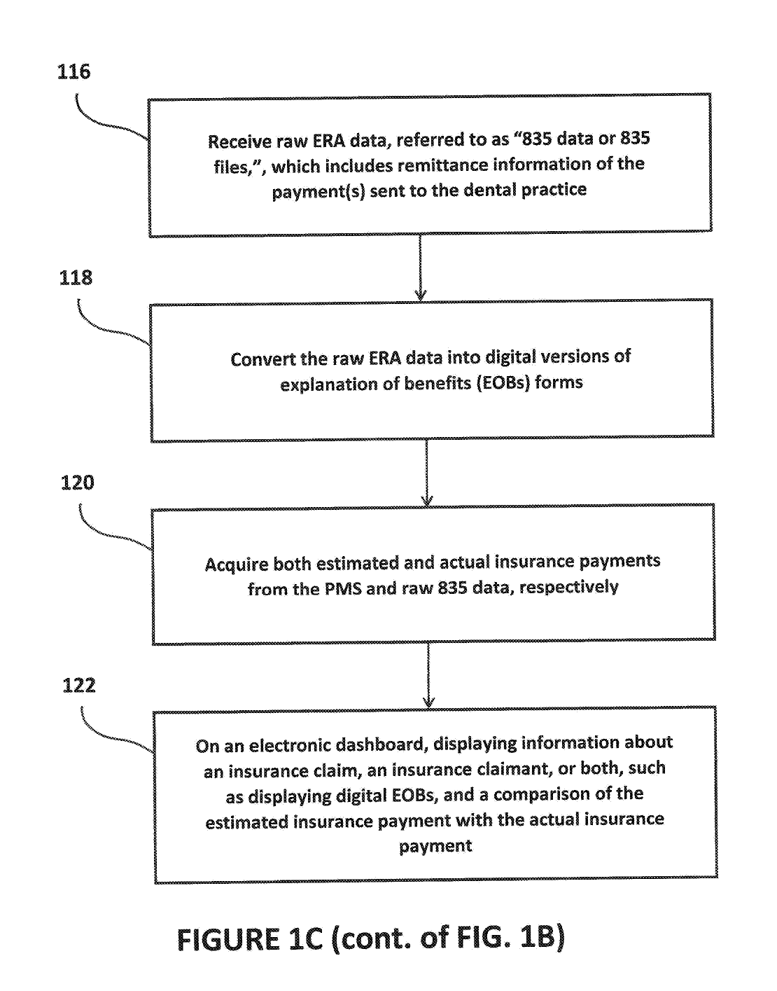

Referring to FIG. 1A and 1B, one purpose of the present invention is to provide a system and method 100 for dental practices to become enabled to conduct EFT transactions with the payors associated with the dental practice or at least the payors chosen by the dental practice and contemporaneously receive adequate, electronic EOBs. Adequate simply means the EOBs include the necessary information for the staff or personnel of the dental practice to have an informed amount of knowledge regarding the claimed services and associated insurance claims. For purposes of the present invention, the dental practice works with the claims manager to engage in an enrollment process, herein referred to as the “Woods Enrollment (WE)” process.

At Step 102, the claims manager begins the WE process by obtaining specific or requisite information from the dental practice during an onboarding session. Typically, such onboarding sessions take about thirty (30) minutes or less. In one embodiment, the WE process includes a dynamic, online form that prompts the dental practice to enter the requisite information to enable their enrollment. Preferably, the online form is configured to prompt for the necessary information that is insurer and/or clearing house specific without collecting unnecessary information that would only take more time to input by the dental practice. Once the online form has been completed by the dental practice and submitted to the claims manager the claims manager securely stores the requisite information or data into a relational database on a server in Step 104 such as, but not limited to, an AMAZON® Web Services (AWS) server. At Step 106, the claims manager generates PDFs to facilitate the EFT/ERA connection between the dental practice and one or more payors. Many payors and clearing houses only allow for EFT/ERA enrollment through the submitting of a PDF template provided by the payor or clearing house. All of the data required to complete the PDF, such as, but not limited to, provider information (e.g., provider name and National Provider Identifier (NPI), dental practice information (e.g., address, contact details for selected personnel, tax identification number (TIN)), banking information (e.g.,account and routing numbers), etc. is collected during the WE process. In one embodiment, The PDF is completed through a Python script which identifies the required data fields in the PDF template and fills them in with the corresponding data collected and stored in the database.

Optionally at Step 108, the claims manager may generate PDFs to manually enroll the dental practice with only specific payors chosen by the dental practice.

At Step 110, the claims manager obtains access to the database for the practice management software or system (PMS) of the dental practice as well as the dental practice’s clearing house. Access to the dental practice’s clearing house permits the claims manager to see the claims and ERAs housed by the clearing house associated with the dental practice’s account. During the onboarding and enrollment process, the dental practice provides authorization for the claims manager to access their clearing house. At Step 112, the claims manager configures an electronic connection with the payor(s) and/or clearing house(s) identified by the dental practice. At Step 114, the claims manager prepares and submits one or more electronic remittance applications (ERAs) to the payors, which may also be sent through one or more clearing houses. In one embodiment, the ERAs include a request for the payor to activate their electronic funds transfer (EFT) process with respect to the dental practice.

Once the EFT process between the payor and the dental practice has been activated at Step 116, which may take several weeks, the payor will begin transmitting raw data files to the clearing house. In one embodiment, the raw data files are referred to as “835 files.” The raw data files provide the necessary information about the remittance of payments transmitted by the payor via the EFT process.

At Step 118 and according to one embodiment, the raw data files are obtained when the claims manager activates a “crawler” program that periodically identifies and pulls any new raw data files that have been transmitted to the clearing house(s) by the payor(s). By way of example, the crawler program may log into the clearing house’s database to identify and download the new raw data files.

At Step 120, any new raw data files are translated or converted into digital EOBs, which may look similar to traditional EOBs previously received through the regular mail system. At Step 122, the digital EOBs may be displayed on a dashboard made accessible by the claims manager for one or more end users (e.g., staff, personnel, coordinator, manager, etc.) associated with the dental practice. Additionally or alternatively, the claims manager, while accessing the PMS of the dental practice, may also display an “estimated insurance payment” and an “actual insurance payment” on the dashboard to allow the end user to see the comparison between them. Optionally, the claims manager may refine or otherwise massage the information translated into the EOBs based on specific requirements that the dental practice or the end users deem to be helpful.

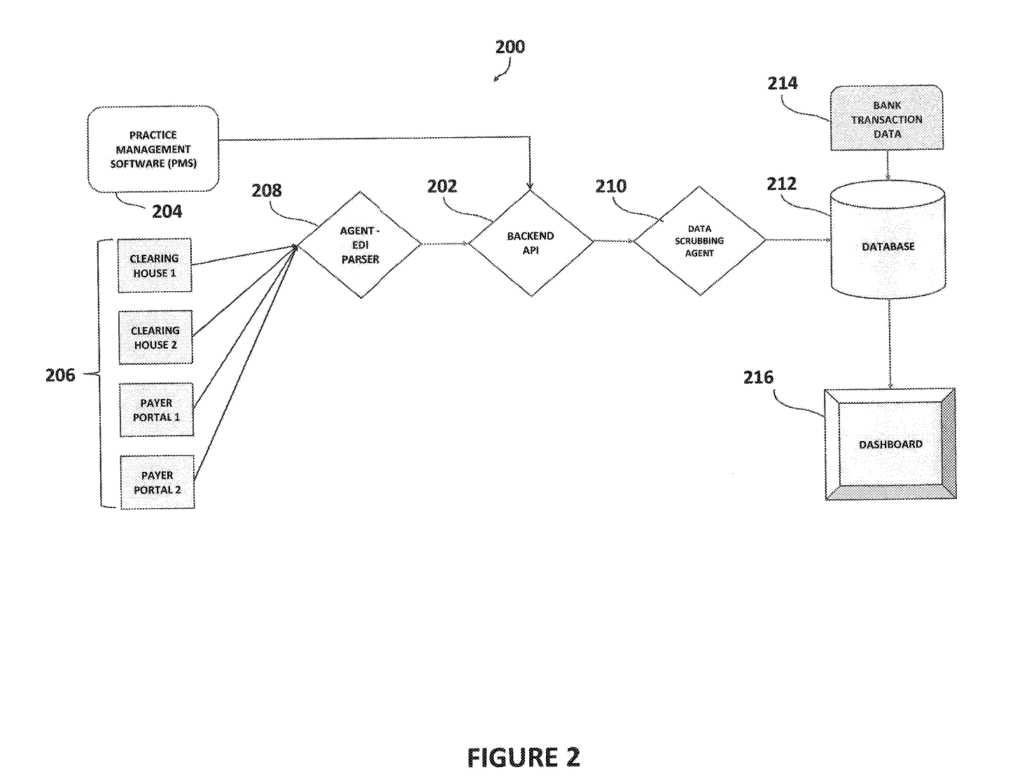

In another embodiment of the present invention and referring to FIG. 2, a claims management system 200 includes a backend application programming interface (API) (hereinafter, “backend API”) 202 in communication with a practice management software (PMS) platform (hereinafter, “PMS”) 204. The PMS tracks the initial insurance claim data prepared by the dental practice in accordance with the insurance claims before they have been sent to the payor. Such initial insurance claim data may include, but is not limited to, the type or types of services rendered by the dental practice, the estimated claim amount as computed by the dental practice, and an estimate of which services will actually be covered as determined by the dental practice. The backend API 202 acquires said initial insurance claim data from the PMS 204. The PMS may be a platform developed by the dental practice but will typically be a platform licensed by the dental practice and configured specifically for the dental practice.

Contemporaneously, an electronic data interchange (EDI) parsing agent (hereinafter, “EDI parsing agent”) 208 communicates with one or more clearing houses, payors, or both (hereinafter, generally and collectively referred to as “clearing house(s)”) 206. The EDI parsing agent 208 retrieves electronic remittance advice (ERA) application data (hereinafter, “ERA data”) in its raw form from portals controlled by the clearing house. The EDI parsing agent 208 is similar to the “crawler” program described above in that, when activated, the EDI parsing agent periodically identifies and pulls any new, raw ERA data that has been made available by the clearing house(s). The raw ERA data is typically referred to as “835 files” and includes the information that details which services are actually covered by the insurance company and the amount of such coverage. While the terms clearing house and payor may be used interchangeably, in one embodiment the clearing house merely operates as a conduit for the payor to transmit data.

The backend API 202 also communicates with the EDI parsing agent 208 to retrieve the raw ERA data parsed by the EDI parsing agent and combine it with the insurance claim data received from the PMS 204. As previously mentioned, the raw ERA data is referred to as 835 files or 835 data, which is typically a text file that is difficult for a human to read it in its raw form. Thus, the EDI parsing agent parses or otherwise extracts the elements of the 835 file that are necessary to determine at least the insurance claim payment amount. The EDI parsing agent may also parse or otherwise extract the 835 data and configure that data into various helpful fields such as, but not limited to, deductible amounts, patient names, etc.

The system 200 further includes a data scrubbing agent 210 that functions to primarily identify, flag, and optionally fix errors related to the data received by the insurance company, the clearing house, or both, such as, but not limited to, deductible amounts, payment amounts, etc. In one embodiment of the present invention, the data scrubbing agent 210 looks at the context of the error and analyzes how that error, in that context, compares to other, similar claims. Optionally, the data scrubbing agent 210 may be a self-learning program. By way of example, the data scrubbing agent 210 is an algorithm that determines if the original data is reasonable or closely aligned with similar data points in the other claims. By way of example, if a deductible is shown as one-hundred and sixty-seven dollars ($167 USD) when more than ninety-eight percent (98%) of deductibles in the other claims are less than fifty dollars ($50 USD), then the data scrubbing agent 210 corrects the error, flags the error for personnel in the dental office, or some combination thereof. This data scrubbing process purposefully happens before the data is transferred to a database 212.

The database 212 combines the scrubbed data received from the data scrubbing agent 210 with bank transaction data 214 received from a banking or other financial institution. The database 212 primarily functions as the codebase or repository. Additionally or alternatively, the database 212 provides persistent and redundant data storage through services such as object storage (e.g., AMAZON® S3) and managed databases (e.g., relational or NoSQL services). The database 212 stores structured and unstructured data, including user records, transaction data, and uploaded documents (e.g., EOBs, the 835 files, PMS data, parsed data, etc.). The database also communicates with and receives requisite banking transaction data 214 from banking or financial institutions for the purpose of processing insurance claims. The banking transaction data 214 is also stored in the database 212. The database 212 may replicate data across multiple geographic locations to ensure durability and fault tolerance. The database 212 enables rapid retrieval and querying of data through indexed and managed database services.

In the present embodiment, the database 212 stores the codebase (i.e., code or application logic) for the system 200, which in turn is executed on provisioned computing resources (e.g., virtual servers or containerized environments). By way of example, the database 212 may Run backend processes such as payment processing workflows, claim reconciliation, and API handling. The database 212 may automatically scale computing capacity up or down depending on system load. The database 212 may also support stateless and stateful services for handling concurrent user interactions.

Additionally or alternatively and in accordance with an embodiment of the present invention, the database 212 provides security and compliance by employing built-in security mechanisms that support regulatory compliance (e.g., healthcare-related standards such as the Health Insurance Portability and Accountability Act (HIPAA). By way of example, the security mechanisms may provide for the encryption of data both at rest and in transit; identity and access management (IAM) to restrict system access to authorized users and services; and network isolation via virtual private cloud (VPC) configurations and firewall rules; and audit logging and monitoring to track system activity and detect anomalies.

The database 212 enables secure transmission of data between system components and external entities via API endpoints that allow third-party integrations (e.g., insurance systems, payment processors); load balancing and routing services that distribute incoming requests efficiently; and content delivery and networking services that optimize latency and reliability.

The system 200 further includes a dashboard 216 configured and arranged to quickly and easily display useful information to the dental practice. By way of example, the end users of the dashboard are the office (dental practice) managers or, if the office has one, the insurance coordinator because they have historically been tasked with collecting the insurance claim payments and entering them in a ledger or spreadsheet. The dashboard advantageously brings together the different data elements an office manager needs into one place.

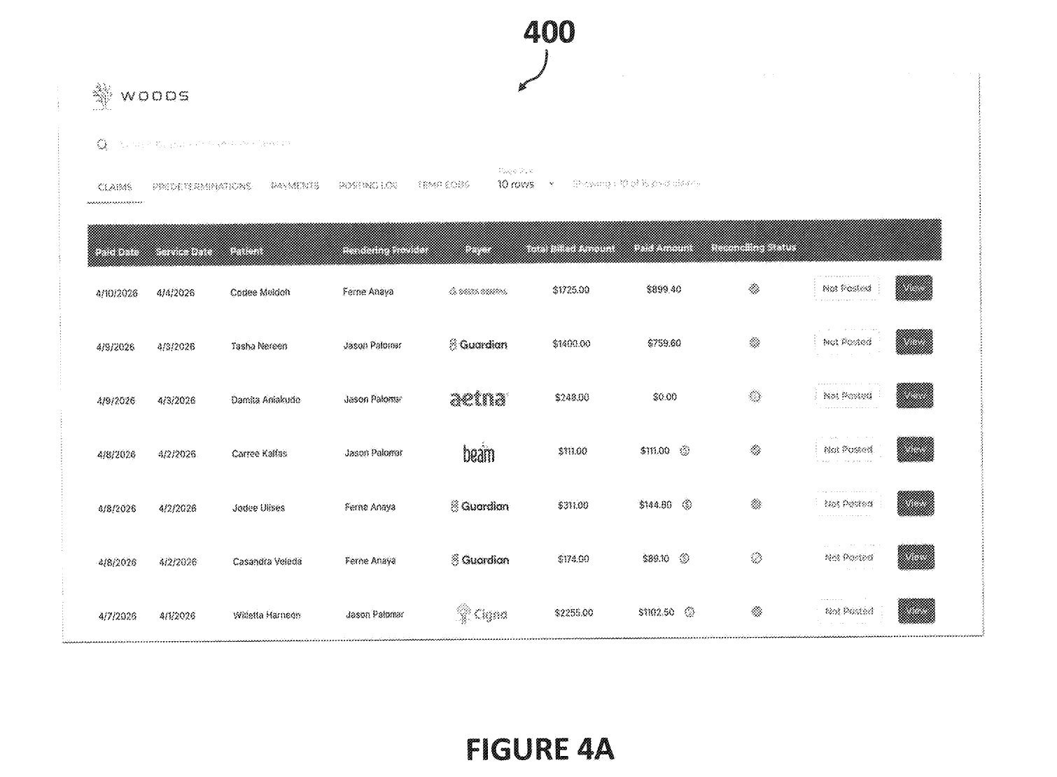

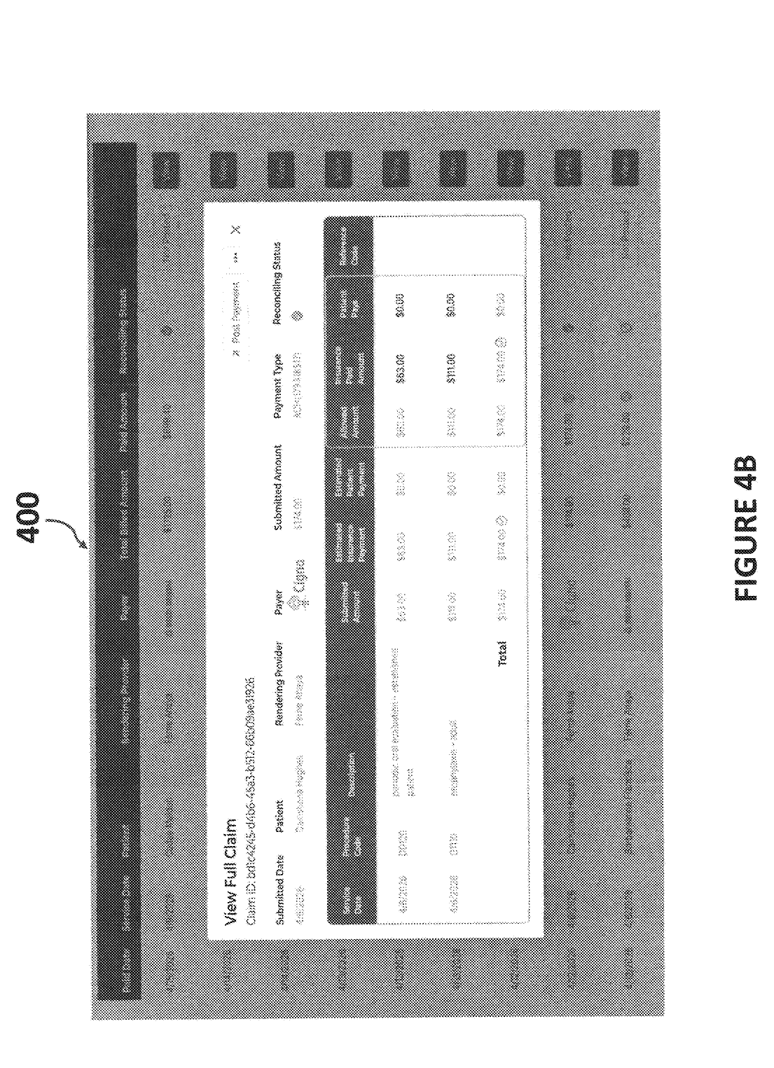

Briefly referring to FIG. 4, the dashboard 216/400 may include information such as, but not limited to ERA data, which includes the detail needed for the adjudication and payment of an insurance claim. By way of example, dashboard 216/400 may display the ERA data, estimated insurance payment information, and payment deposit notifications. The ERA data typically resides in a hardcopy EOB or on a payor portal but may now be easily displayed on the dashboard 216/400. The estimated Insurance payment information is extracted from the PMS 204 and allows the claims manager to quickly compare it with the actual payment information, and if needed, alert the dental practice in case any discrepancies are identified. The payment deposit information operates to alert the dental practice that funds have been deposited into the bank account and whether those funds match what the insurance company communicated that they would pay.

In yet another embodiment of the present invention, the dashboard 216 includes a post payment function that transfers the ERA data into the PMS 204 via the activation of an electronic trigger rather than manual data entry.

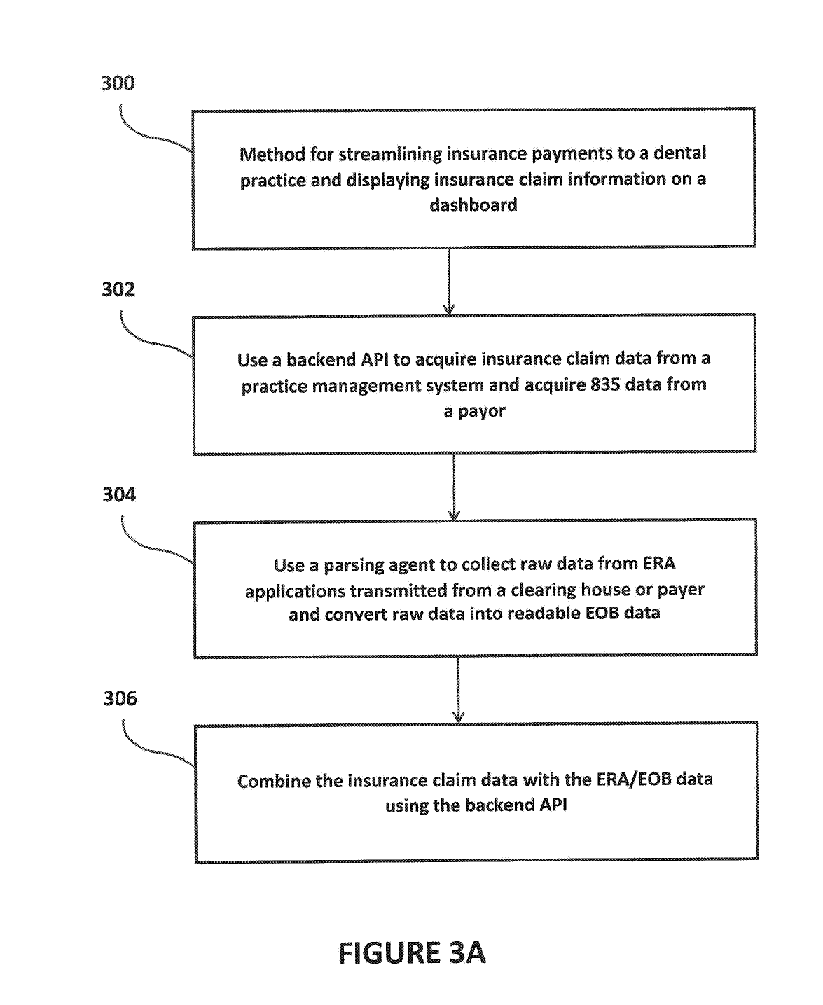

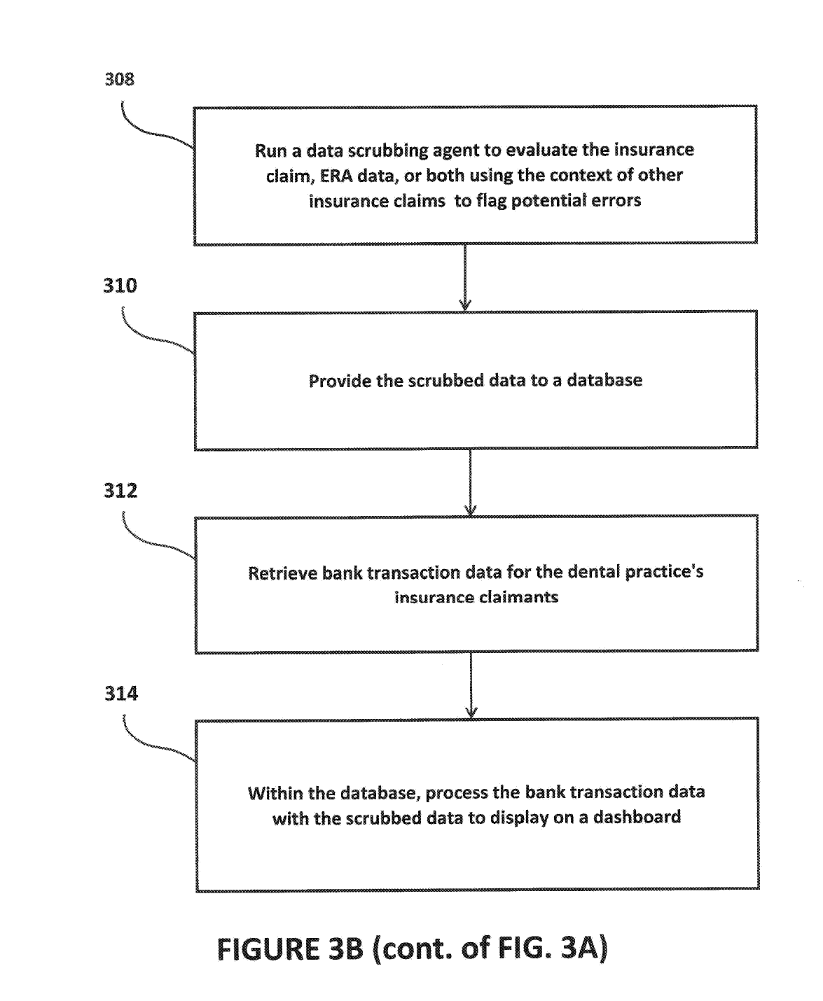

In association with FIG. 2 and now referencing FIGS. 3A and 3B, a method 300 for streamlining payments from an insurance company to a dental practice. The method 300 generally follows the process of the system 200 of FIG. 2 and the reference numerals used in FIG. 2 will be used herein for convenience and clarity. At Step 302, the backend API 208 acquires insurance claim data from the PMS 204 and acquires 835 data from one or more payors 206. At Step 304, the parsing agent EDI parsing agent parses or otherwise extracts the 835 data and configures that data into various helpful fields as described in more detail above. At Step 306, insurance claim data and ERA/EOB data are collected by the backend API 208. At Step 308, the data scrubbing agent 210 is activated and ran to evaluate the insurance claim data, the ERA/EOB data, or both using the context of other insurance claims to flag potential errors. At Step 310, the data scrubbing agent 210 transmits the scrubbed data to the database 212. The database 212 retrieves or has already retrieved bank transaction data 214 from one or more banking or financial institutions relative to one or more insurance claims or claimants. At Step 314, the scrubbed data and the banking transaction data are processed, configured, and arranged for display on the dashboard 216.

FIG. 4A shows the dashboard 400 in accordance with an embodiment of the present invention. For purposes of the present disclosure, the data shown in FIG. 4 was fabricated for illustration purposes only and does not reflect any known claimants or claims. The dashboard 400 displays a variety of data fields, preferably the data fields that have been identified to be relevant and important to the dental practice for assessing the status of a pending insurance claim. FIG. 4B shows a pop-up window selectable by an end user in which the pop-up window includes a subset of the data fields shown in FIG. 4A or other data fields as selected by the end user.

One of the benefits associated with the present invention includes the claims manager setting up the connections and communications between the payors and clearing houses to collect the electronic EOBs (aka ERAs) and aggregate them into a repository controlled by the dental practice. Another benefit is the electronic EOBs may then be made available for display to end users (e.g., dental practice staff, personnel, coordinator, manager, etc.) on a dashboard, which is referred to herein as the “Woods Dashboard (WD).” Yet another important advantage of the inventive process is that the dental practice receives insurance claim payments quickly and securely without having to pay any VCC or other cost-accumulating fees. And yet another advantage of the inventive process allows the dental practices to reconcile their insurance claims quickly and display these results to the end users via the WD. It is appreciated that these and many other benefits and advantages whether expressly mentioned herein or not may be contributable to the present invention.

Another benefit of the present invention is that it may also be utilized by third-party billers contracted by the dental practice to handle insurance billing and payments.

As one of skill in the art will appreciate, the many varying features and configurations described above in relation to the several exemplary embodiments may be further selectively applied to form the other possible embodiments of the present invention. For the sake of brevity and considering the abilities of one of ordinary skill in the art, each of the possible iterations is not provided or discussed in detail, though all combinations and possible embodiments embraced by the several claims below or otherwise are intended to be part of the instant

application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the embodiments described in the present application, and that numerous changes and modifications may be made herein without departing from the spirit and scope of the present application as defined by the following claims and the equivalents thereof.

That which is claimed:

1. A process for streamlining the receipt of payments from an insurance company to a dental practice, the process comprising:
obtaining access to the practice management software (PMS) of a dental practice;
acquiring specific information about the dental practice;
generating one or more portable document files (PDFs) based on the specific information acquired regarding the dental practice;
using the PDFs, preparing and submitting one or more electronic remittance advice (ERA) applications to a clearing house used by the dental practice;
wherein submitting the ERA application includes making a request for the clearing house to activate an electronic data interchange (EDI) process that places the insurance company, the clearing house, and the dental practice in electronic communication for the purpose of at least processing payment requests originated by the dental practice for payment by the insurance company;
after activation of the EDI process, receiving raw text files into the clearing house, wherein the raw data files provide the remittance information of the payment sent by the insurance company;
electronically communicating with the clearing house on a periodic basis to obtain and download new raw data files;
converting the data from the raw data files into digital versions of explanation of benefits (EOBs) forms;
acquiring an estimated insurance payment from the PMS of the dental practice;
acquiring an actual insurance payment obtained from the conversion of the raw data file; and
on an electronic dashboard, displaying the digital EOBs and displaying a comparison of the estimated insurance payment with the actual insurance payment.

2. The process of claim 1, wherein obtaining access to the PMS includes obtaining access to a clearing house utilized by the dental practice.

3. The process of claim 1, wherein the raw data files are referred to as 835 files.

4. The process of claim 1, wherein electronically communicating with the clearing house periodically includes electronically communicating with the clearing house at least once per hour.

5. The process of claim 1, wherein electronically communicating with the clearing house includes using a “crawler” program to communicate with the clearing house.

6. The process of claim 1, wherein converting the data from the raw data files includes “massaging” the raw data to be better comprehended by a viewer of the dashboard.

7. A process for streamlining payments from an insurance company to a dental practice, the process comprising:
using a backend application programming interface (API) controlled by the claims manager, acquire insurance claim data from a practice management software (PMS) system used by the dental practice;
using a parsing agent controlled by the claims manager, collecting raw data from electronic remittance advice (ERA) applications transmitted from at least one clearing house portal, a payor portal, or both, wherein the parsing agent separates and translates the raw data into legible explanation of benefit (EOB) data;
combining the insurance claim data with the EOB data with the backend API;
applying a data scrubbing agent to evaluate the insurance claim data, the ERA data, or both, wherein the data scrubbing agent uses the context of other insurance claims to determine whether a particular data set received from the backend API includes any errors;
providing the scrubbed data to a database;
retrieving bank transaction data for insurance claimants of the dental practice, wherein the bank transaction data is received from one or more banking institutions for processing within the database, and;
within the database, processing the bank transaction data and the scrubbed data for display on a dashboard.

8. The process of claim 7, wherein the parsing agent is an electronic data interchange (EDI) parsing agent.

9. The process of claim 7, wherein the raw data files are referred to as 835 files.

10. The process of claim 7, wherein the data scrubbing agent evaluates errors by determining if the value of the data set appears to be reasonable to values of similar data sets.

11. The process of claim 10, wherein errors identified by the data scrubbing agent are flagged for review by one or more dental practice personnel.

12. The process of claim 7, wherein the database takes the form of a cloud-based computing infrastructure system.

13. The process of claim 7, wherein the database is an Amazon Web Service (AWS) database.

14. The process of claim 7, wherein the information displayable by the dashboard allows dental practice personnel to evaluate the status of an insurance claim, an insurance claimant, or both based on the information displayed on the dashboard.
